(19) United States
(12) Patent Application Publication
(10) Pub. No.: US 2021/0216711 A1
(43) Pub. Date: Jul. 15, 2021

(54) Data Analysis, Rating, and Prioritization Process and Platform

(71) Applicant: Shaun Alger, Carlsbad, CA (US)

(72) Inventor: Shaun Alger, Carlsbad, CA (US)

(21) Appl. No.: 17/148,460

(22) Filed: Jan. 13, 2021

Related U.S. Application Data
(60) Provisional application No. 62/960,317, filed on Jan. 13, 2020.

(51) Int. Cl. G06F 40/279; G06F 40/30; G06F 16/31; G06F 16/35; G06Q 10/06

(52) U.S. Cl. CPC G06F 40/279; G06F 40/30; G06Q 10/06393; G06F 16/358; G06F 16/313

(57) ABSTRACT

A platform for performing a process of data analysis, rating, and prioritization in order to increase an organization's revenue generates a heat map from collected raw data in order to show areas in which an organization's activities are highly effective, and areas which need improvement. The heat map is generated by processing raw data input into a set of weighted scores or functions, and using the weighted scores to determine a score and a textual summary for each portion of the heat map. The score corresponds to a color on the heat map, and the textual summary indicates why an organization is effective in a specific area of activity or what the organization needs to improve in that area of activity.

### RELATED APPLICATION

This application claims the benefit of priority to U.S. Provisional Patent Application Ser. No. 62/960,317 for a “Data Analysis, Rating, and Prioritization Process and Platform,” filed Jan. 13, 2020, and currently co-pending, the entirety of which is incorporated herein by reference.

### FIELD OF THE INVENTION

The present invention pertains generally to platform for use in analyzing data. More particularly, the present invention pertains to a process and platform for analyzing data and generating a prioritized list of actions. The Present invention is particularly, but not exclusively, useful as a process for maximizing an organization's revenue-generation capabilities.

### BACKGROUND OF THE INVENTION

It is a well-known maxim that most startups fail. In general, running a business can be a risky, competitive undertaking, even for medium and large enterprises, which occasionally undergo spectacular failures. Business failures have many causes, but money plays a central role in virtually every case. Thus, many business failures could be avoided by an improved revenue ecosystem. Since the economy depends on the success of businesses, improving business revenue would benefit not only the individual businesses, but society as a whole.

In light of the above, it would be advantageous to provide systems and tools to increase the efficiency and effectiveness of sales and marketing teams.

### SUMMARY OF THE INVENTION

Disclosed is a process for data analysis, rating, and prioritization and platforms for performing the process. Preferred embodiments of the process are particularly useful for increasing an organization's marketing and sales effectiveness, thereby increasing the organization's revenue.

The process includes the gathering and analysis of data, and the production of a plan of action based on the results of the analysis. A preferred embodiment of a platform for performing the process generates a heat map from collected raw data in order to show areas in which an organization's activities are highly effective, and areas which need improvement. The heat map is generated by processing raw data input into a set of weighted scores or functions, and using the weighted scores to determine a score and a textual summary for each portion of the heat map. The score corresponds to a color on the heat map, and the textual summary indicates why an organization is effective in a specific area of activity or what the organization needs to improve in that area of activity.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram illustrating components of a preferred embodiment of a data analysis, rating, and prioritization process;

FIG. 2 is a flowchart illustrating an exemplary sales funnel of a preferred embodiment of a process component of a data analysis, rating, and prioritization process;

FIG. 3 is a flowchart illustrating a high-level overview of a preferred embodiment of a data analysis, rating, and prioritization process;

FIG. 4 is a block diagram illustrating elements of a preferred embodiment of a data gathering step of a data analysis, rating, and prioritization process;

FIG. 5 is a block diagram illustrating elements of a preferred embodiment of an analysis step of a data analysis, rating, and prioritization process;

FIG. 6 is a block diagram illustrating elements of a preferred embodiment of an execution step of a data analysis, rating, and prioritization process;

FIG. 7 is a block diagram of a preferred embodiment of a platform for data analysis, rating, and prioritization;

FIG. 8 is a diagram of a preferred embodiment of an algorithm for transforming raw data into functions or data structures representing weighted values;

FIG. 9 illustrates an exemplary heat map generated by the platform of FIG. 7;

FIG. 10 illustrates a table of textual summaries used for generating a heat map;

FIG. 11 illustrates a process for generating a heat map;

FIG. 12 illustrates a preferred embodiment of a marketing dashboard used in a data analysis, rating, and prioritization process;

FIG. 13 illustrates a preferred embodiment of a sales dashboard used in a data analysis, rating, and prioritization process; and

FIG. 14 illustrates a goal completion dashboard used in a data analysis, rating, and prioritization process.

### DETAILED DESCRIPTION

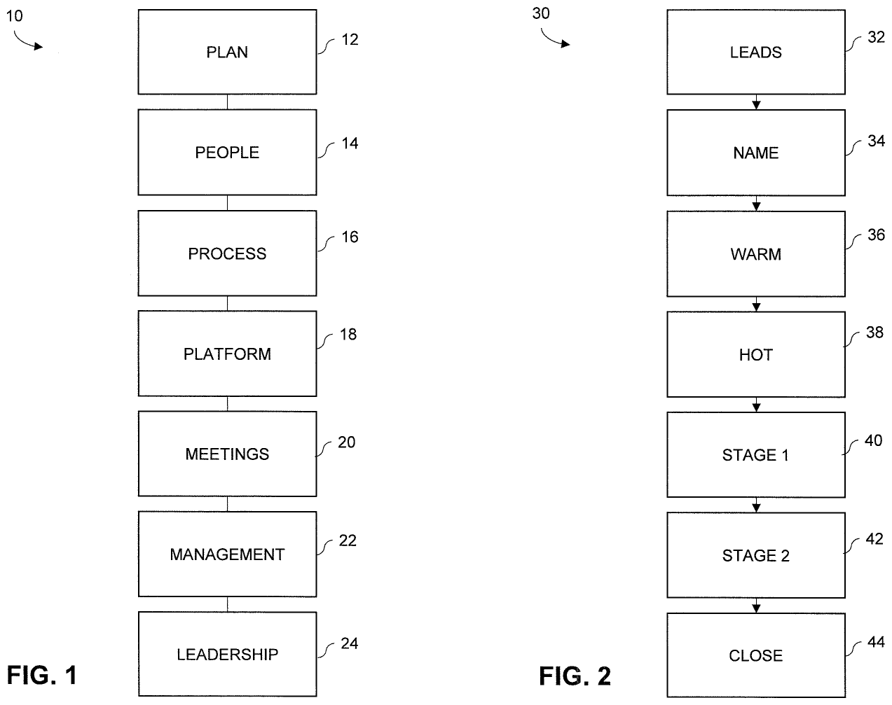

Referring initially to FIG. 1, an overview of components of a preferred embodiment of a data analysis, rating, and prioritization process is illustrated and generally designated 10. One component is a plan component 12, which, in preferred embodiments, includes the preparation and analysis of business plans, marketing plans, cash flow, messaging, and growth.

People component 14 includes the generation of a predictive index, discussed further below, and team interviews. Presentation of collected and processed data, including the generation of organizational charts and success metrics also form part of preferred embodiments of people component 14, as do recruiting, activity optimization, the determination of roles and responsibilities, and compensation plans.

Process component 16 includes sales steps, marketing, and data and analytics related to sales and marketing. A/B testing is used to evaluate and tune the effectiveness of process component 16. Lead generation, social media, distribution plans, scripts, and related materials are prepared and fine-tuned based on the acquired data and associated analysis.

Platform component 18 includes customer relationship management (CRM), sales, and marketing platforms, including dashboards and reports generated by the platforms and further discussed below.

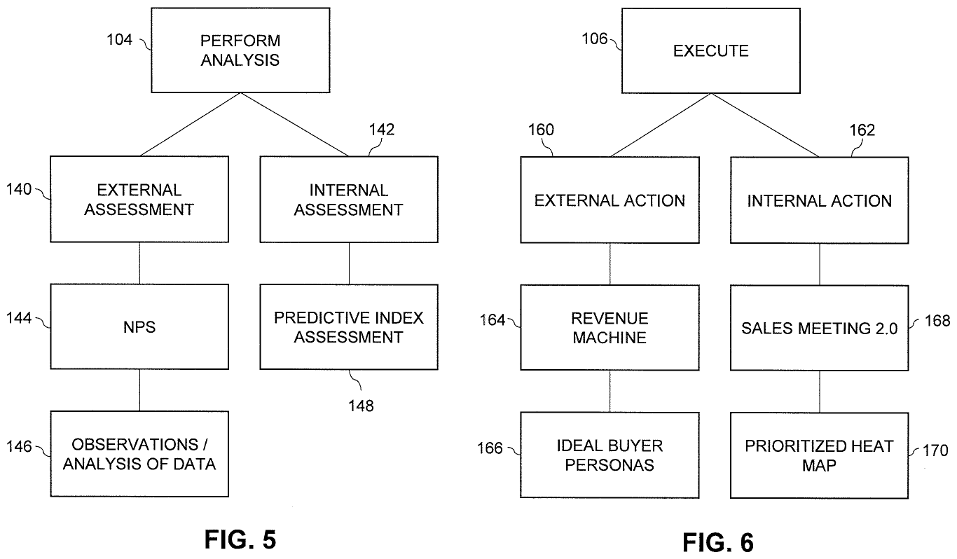

Meetings component 20 includes Sales Meeting 2.0 platform 168 (shown in FIG. 6).

Management component 22 includes one or more of management training, management assistance, and providing partial chief revenue officer (CFO) services.

Leadership component 24 includes communication and leadership training.

Referring now to FIG. 2, sales steps according to a preferred embodiment of process 16 are illustrated and generally designated 30. Sales steps 30 include step 32 of acquiring leads, name step 34, warm step 36, hot step 38, first stage step 40, second stage step 42 and closing step 44, at which point the leads are converted or “onboard.” Scripts and templates for each step of sales steps 30 are prepared and refined as part of process 16.

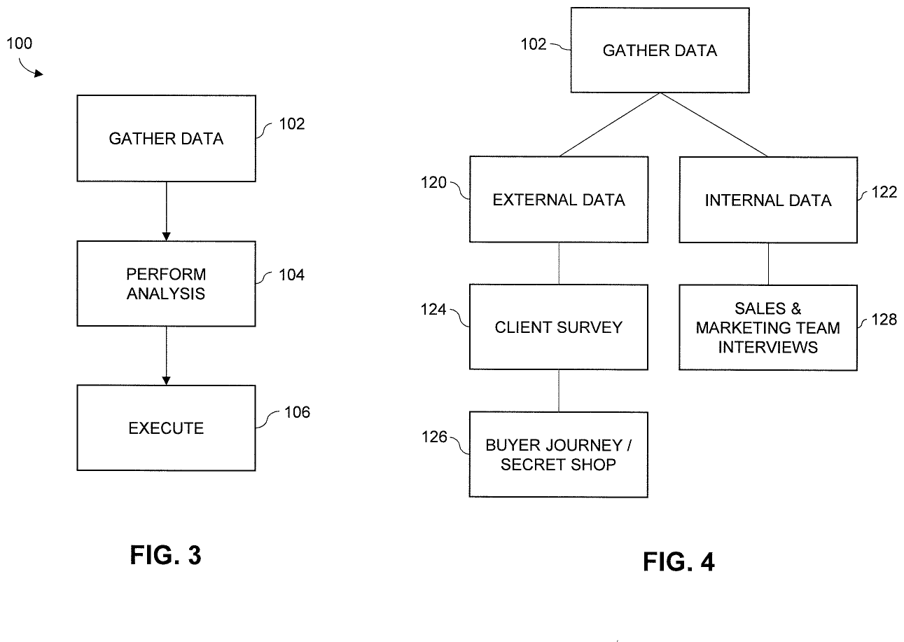

Referring now to FIG. 3, a data analysis, rating, and prioritization process 100 can be summarized at a high level in terms of three steps, including a data gathering step 102, an analysis step 104, and an execution step 106. Preferred embodiments of process 100 are particularly useful for optimizing the revenue-generating processes of an organization and maximizing revenue. Embodiments of process 100 may be performed simultaneously in order to optimize various aspects of an organization's revenue-generating process. For example, one embodiment of process 100 for hiring sales and marketing team members can be performed alongside an embodiment of process 100 for improving the effectiveness of an existing sales and marketing team and an embodiment of process 100 for generating customer profiles and building sales steps based on ideal customer personas.

Some embodiments of process 100 include other embodiments of process 100 in their steps in a recursive manner. For example, one preferred embodiment of process 100 gathers general data about an organization, including current revenue and goals for improvement in step 102. In step 104, embodiments of process 100 are performed in order to gather more detailed data about the organization's sales team (step 102), current customers, etc., analyze the data (step 104), and build assessments, sales steps, buyer, personas, dashboards, etc. (step 106). The results of step 106 of the sub-processes 100 are used the analysis step 104 of the overall process 100, and are used as part of an overall plan to meet the organization's goals in step 106.

Referring now to FIG. 4, exemplary data items gathered in steps 102 by some preferred embodiments of process 100 are illustrated. In optimizing an organization's revenue generation, it is often necessary to obtain both external data 120 and internal data 122. External data 120 includes information about factors external to the organization that affect the organization's revenue, such as market information, information about competitors, information about current, past, and prospective clients, and other similar types of information. A client survey is used in the data gathering step 102 of some embodiments of process 100 in order to obtain information from clients of the organization. A “buyer's journey” or “secret shopping” 126 is also used in some embodiments in order to obtain information about an organization's competitors.

Internal data 122 includes information about the organization itself, including the sales and marketing team, the business plan and policies of the organization, the organization's work culture, and other information about the organization that affects revenue generation. Sales and marketing team interviews 128 are used in some preferred embodiments in order to obtain a portion of the needed internal data 122.

Referring now to FIG. 5, exemplary actions taken during analysis steps 104 of some preferred embodiments of process 100 are illustrated. Actions taken as part of an external assessment 140 and actions taken as part of an internal assessment 142 are illustrated. As part of external assessment 140, a Net Promoter Score (“NPS”) 144 is calculated in preferred embodiments. NPS 144 is a measure of customer loyalty, and is calculated as the difference between the percentage of customers who are “promoters” of an organization and the percentage of customers who are “detractors” of an organization as determined by a survey question. The survey question is generally a question similar to: “How likely is it you would recommend us to a friend?” Preferred embodiments of analysis step 104 also include analysis 146 of other data obtained, including other data from customer surveys, as part of external assessment 140.

Internal assessment 142 of preferred embodiments if analysis step 104 include the generation of a predictive index (“PI”) team assessment based on internal data 122, including sales and marketing team interviews 128.

Referring now to FIG. 6, in a preferred embodiment of process 100, execution step 106 includes external action 160, meaning action taken based on external assessment 140 of external data 120, and internal action 162, meaning action taken based on internal assessment 142 of internal data 122. External action 160 includes the generation and use of revenue machine 164, a preferred embodiment of which is a set of sales steps determined based on the results of external assessment 140. Ideal buyer personas 166 are also generated based on external assessment 140, allowing the organization to identify and pursue the ideal client.

Internal action 162 includes the building or customization of a sales platform for the organization, including collaborating with leaders to build a Sales Meeting 2.0 platform 168 with dashboards and metrics of sales success and conversion.

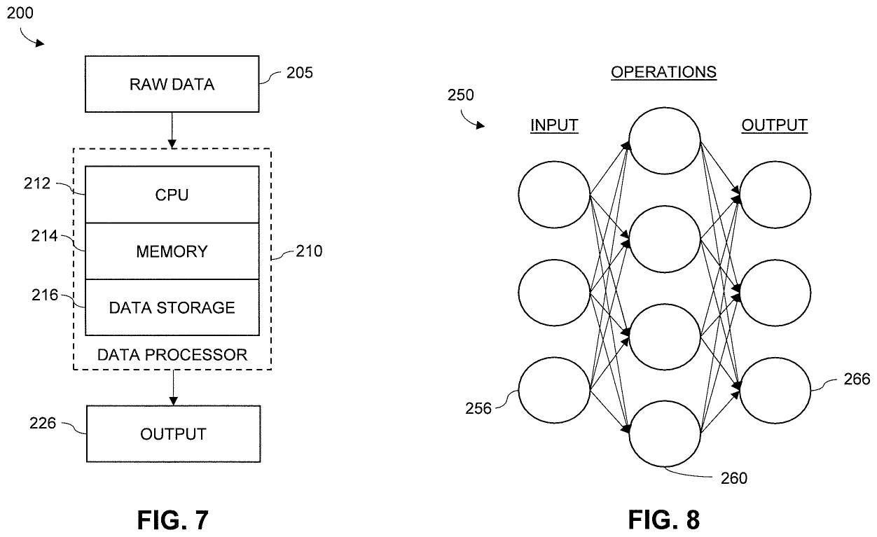

Referring now to FIG. 7, a preferred embodiment of a platform 200 for data analysis, rating, and prioritization is illustrated. In the operation of platform 200, raw data 205 is provided to a data processor 210, which has a central processing unit (“CPU”) 212; a non-volatile working memory 214, which in preferred embodiments is at least partly random-access memory (RAM); and a data storage 216. A non-volatile memory, which in some embodiments is part of data storage 216, contains instructions configured to cause the CPU 212 to place raw data 205 into working memory 214 and to perform operations on raw data 205 resulting in an output 226. Platform 200 is useful as a standalone data analysis, rating, and prioritization platform, and also useful as part of a larger data analysis, rating, and prioritization platform containing one or more platforms 200.

Referring now to FIG. 8, an algorithm 250 is used for a portion of the operation of data processor 210 in order to convert raw data 205 into values from which output 226 can be generated. In algorithm 250, raw data 205 is provided as input 256 to operations 260 in one or more operations layers, resulting in output elements 266. In a preferred embodiment, output elements 266 are data structures containing sets of weighted values for further processing in order to generate output 226 of platform 200. In another preferred embodiment, output elements 226 are functions that also undergo further processing in order to generate output 226 of platform 200.

Some preferred embodiments of algorithm 250 use deep learning technology in order to adapt output elements 266 over time based on past success or failure of execution step 106 (see FIG. 3). In such embodiments, operations 260 act as artificial neurons in one or more “hidden layers” represented by the operations layer illustrated in FIG. 8. Operations 260 then have a weight that is adjusted over time, increasing or decreasing the likelihood of specific input values resulting in a particular output as the effectiveness of outputs 266 and ultimately output 226 is optimized.

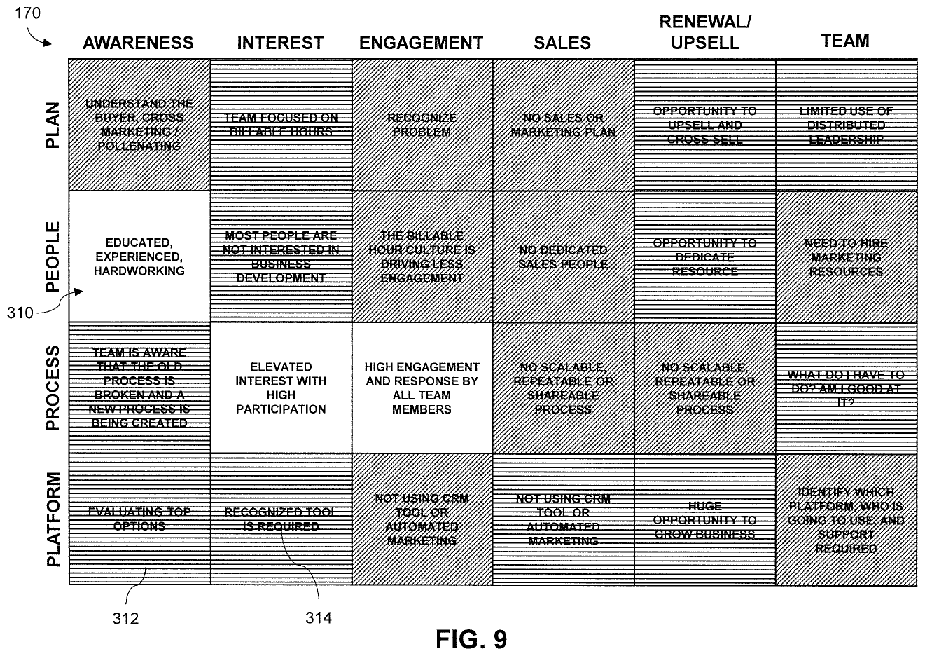

Referring now to FIG. 9, a preferred embodiment of platform 200 uses the processed data to create a heat map 170 as output 226 (shown in FIG. 7) or a portion of output 226. A preferred embodiment of heat map 170 has six columns, one each for awareness, interest, engagement, sales, renewal/upsell, and team, and for rows, one each for platform, process, people, and plan. Heat map 170 therefore has, in a preferred embodiment, twenty-four (24) squares 310, each associated with a set of weighted data inputs. The weighted inputs are processed by the algorithm to generate a score for each square 310, which is represented on heat map 170 by a color 312. Preferred embodiments of heat map 170 have three to four colors 312; green, yellow, and red in one preferred embodiment, and green, yellow, orange, and red in another preferred embodiment. Limiting the number of colors 312 allows the recipient of the heat map 170 to quickly determine what is working well, what needs improvement, and what is working poorly and needs urgent attention. Nonetheless, alternative embodiments with more than four colors 312 are fully contemplated, including embodiments wherein the color 312 of each square, as determined by the calculated score, is selected from hundreds, thousands, or even millions of colors, enabling fine distinctions between close scores.

In addition to the score, the combination of weighted values for each square 310 is used to determine and present a textual summary 314 highlighting the situation of the portion of the enterprise represented by the square 310. Since the textual summary 314 is specific to the situation of a particular portion of a specific enterprise at a specific point in time, preferred embodiments do not simply select a textual summary 314 associated with a score. This is because two different sets of values, after weighting, may result in the same score for different reasons. Thus, one or more dominant elements among the weighted elements for each square 310 are determined, and the textual summary 314 is selected or generated based on those elements. In preferred embodiments, dominant elements are determined by selecting elements having high scores and low scores compared to the majority of elements, or compared to an average score among the elements. In some preferred embodiments, the selection is made by adjusting the scores so that low scores have a negative value, and then comparing the absolute value of the scores, so that one or more dominant elements are determined without regard to whether the element is dominant due to a low score or due to a high score.

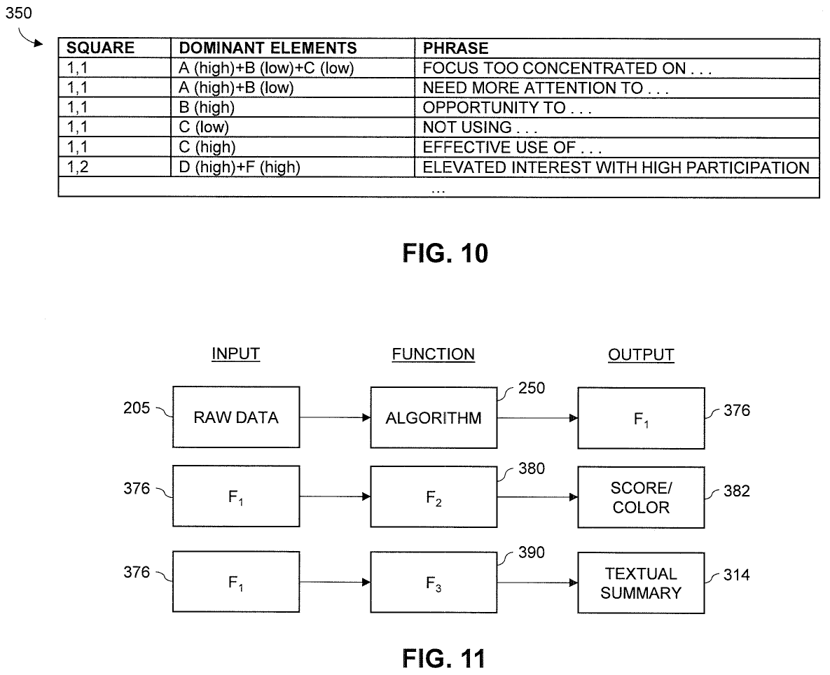

Referring now to FIG. 10, an efficient way of generating textual summaries 314 is the selection of predetermined textual summaries from a table 350 based on the dominant values determined by the algorithm. In a simple embodiment, two entries for each element are stored in the table 350; one entry for the element when associated with a high score, and a second entry for the element when associated with a low score. If more than one element was determined to be dominant, the entries for each dominant element are selected and combined into a compound textual summary 314 by using punctuation, such as a comma or a semicolon, between the selected entries.

In other preferred embodiments, table 350 includes additional entries corresponding to particular combinations of dominant elements, such as two elements with high scores; one element with a high score and another with a low score; or other combinations of two or more elements with their various possible combinations of high and low scores. Some such embodiments select such entries for use as a textual summary 314 when the determined dominant elements match a combination in table 350, and select and combine entries for individual dominant elements as discussed above when no combination in table 350 is matched.

Some alternative preferred embodiments use natural language processing (NLP) technology to generate textual summaries 314 instead of selecting predetermined textual summaries 314 from a table. Some embodiments use simple rules-based NLP in which modifiers, such as “NO,” “NOT,” LIMITED,” “GOOD,” “GREAT,” “HIGH,” “ELEVATED,” etc., are combined with issues such as “INTEREST,” “RESPONSE,” “PARTICIPATION,” “SCALABLE PROCESS,” etc. Both issues and modifiers are selected based on the dominant elements in order to generate the textual summary 314 to be placed in each square 310 of heat map 170. In some cases, the rule sets allow for or require combinations of multiple issues and associated modifiers depending on the dominant elements. For example, where dominant elements for the “ENGAGEMENT”−“PROCESS” square include “engagement and response” by all or a subset of “team members,” the issue “ENGAGEMENT AND RESPONSE” is combined with a modifier such as “HIGH,” “LOW,” or some other modifier or no modifier at all, followed by “BY,” a modifier such as “ALL,” “SOME,” or “NO,” followed by “TEAM MEMBERS.” As a result, a textual summary 314 for the square 310 is generated, one example of which is “HIGH ENGAGEMENT AND RESPONSE BY ALL TEAM MEMBERS” as illustrated in FIG. 9.

Some embodiments use statistical NLP, or a combination of statistical and rules-based NLP in order to provide greater precision in the textual summaries.

Referring now to FIG. 11, a preferred embodiment of the process performed by platform 200 for generating heat map 170 is illustrated and generally designated 370. In process 370, raw data 205 is provided to algorithm 250 in order to generate one or more outputs 266 such as F₁ 376. For illustrative purposes, F₁ 376 is discussed herein as a function; nonetheless it will be apparent to one of ordinary skill in the art that a data structure capable of holding a set of weighted values, such as an array, a hash table, a dictionary, a list, a C-style struct, or other suitable data structure, may be used instead of a function. Whether a function or a data structure is preferable, and which data structure is preferable, depends on the programming language used, whether and to what degree machine learning is used, and related factors. Embodiments using functions and embodiments using the various suitable data structures are fully contemplated herein.

F₁ 376 is provided as input to function F₂ 380 in order to generate a score 382 for selecting the color 312 for a square in heat map 170. In one preferred embodiment, F₂ 380 calculates score 382 by summing up the output of F₁ 376 over a predetermined set of input values, or by summing up the entries of the data structure used in place of F₁ 376.

F₁ 376 is also provided as input to function F₃ 390 in order to generate a textual summary 314 for the square in heat map 170. The textual summary 314 is generated by obtaining the output of F₁ 376 over a predetermined set of values, and determining the dominant elements and generating the text as described above.

Referring now to FIGS. 10-12, exemplary dashboards are illustrated. The dashboards are used in preferred embodiments of a data analysis, rating, and prioritization process and platform in order to measure the results of the execution step 106 of process 100, and for use in data gathering step 102 of repetitions of process 100 in order to continually increase efficiency of an organization's revenue-generating activity.

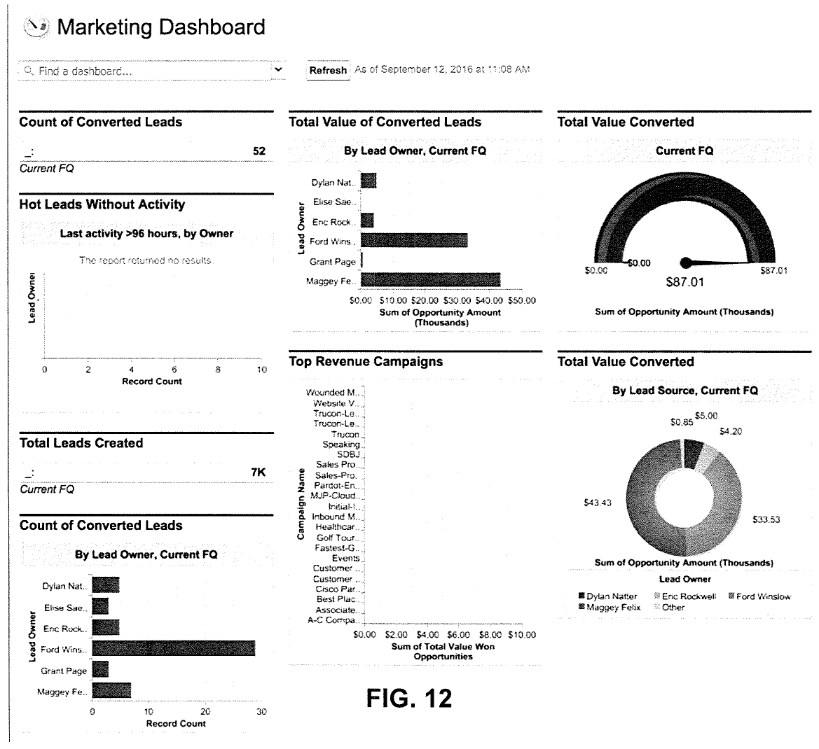

Referring now to FIG. 12, a preferred embodiment of a marketing dashboard is illustrated, showing an overview of sales campaigns, leads, leads without activity, converted leads, and value converted.

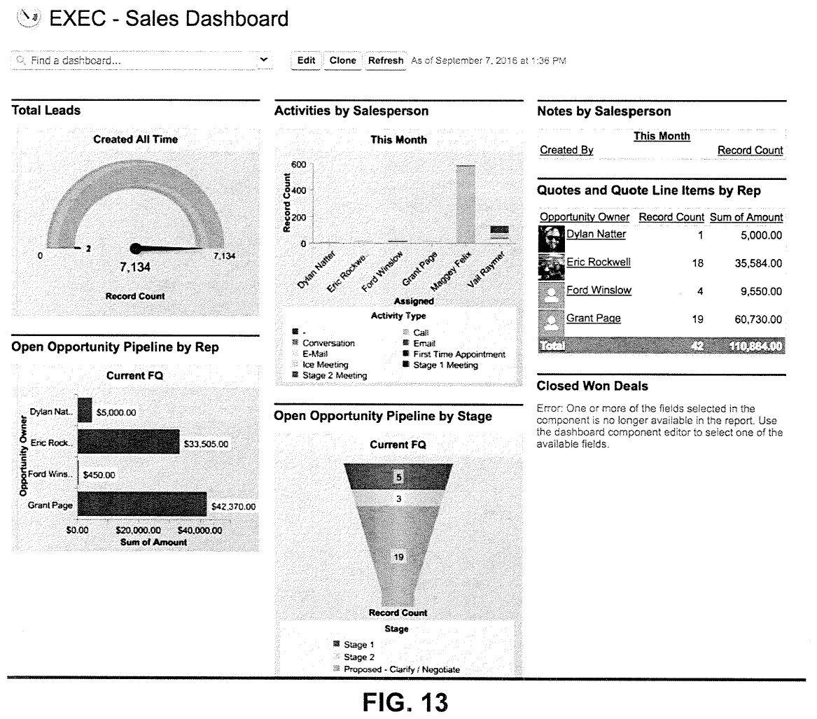

Referring now to FIG. 13, a preferred embodiment of a sales dashboard is illustrated, including an overview of the number of leads, the sales pipeline, and salesperson activity.

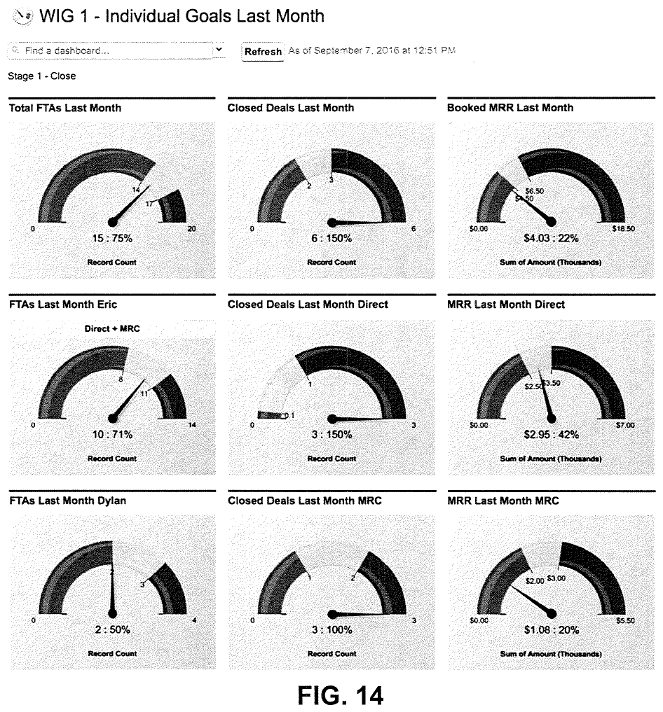

Referring now to FIG. 14, a preferred embodiment of a goals dashboard is illustrated, including overall goals and activity as well as goals and activity for individual salespeople.

While there have been shown what are presently considered to be preferred embodiments of the present invention, it will be apparent to those skilled in the art that various changes and modifications can be made herein without departing from the scope and spirit of the invention.

I claim:

1. A platform, comprising:
a data processor, comprising:
a CPU;
a non-volatile working memory; and
a data storage,
wherein the data processor is configured to receive raw data, operate on the raw data to generate processed data, and generate an output comprising a heat map illustrating the processed data.

2. The platform as recited in claim 1, wherein the processed data comprises a series of scores.

3. The platform as recited in claim 2, wherein the heat map comprises a series of squares, each square representing a score of the series of scores and having a color corresponding to the score.

4. The platform as recited in claim 3, wherein the processed data further comprises a textual summary for each score of the series of scores.

5. The platform as recited in claim 4, wherein the data processor is configured to generate the textual summary for each score of the series of scores using natural language processing (NLP).

6. The platform as recited in claim 4, wherein each square of the heat map further contains the textual summary corresponding to the score represented by the square.

7. The platform as recited in claim 6, wherein the data processor is configured to create weighted inputs from the raw data, and wherein the weighted inputs are processed to generate each score of the series of scores.

8. The platform as recited in claim 7, wherein the data processor is configured to determine one or more dominant elements for each score from the weighted inputs, and wherein the textual summary corresponding to each score is generated based on the dominant elements for the score.

9. The platform as recited in claim 8, wherein the data processor is configured to determine the dominant elements by selecting weighted inputs having high scores and weighted inputs having low scores compared to an average score of the weighted inputs.

10. The platform as recited in claim 1, wherein the output comprises one or more dashboards.

11. The platform as recited in claim 10, wherein the one or more dashboards comprise a marketing dashboard showing an overview of sales campaigns, leads, leads without activity, converted leads, and value converted; a sales dashboard showing an overview of a number of leads, a sales pipeline, and salesperson activity; and a goals dashboard showing overall goals and activity, and goals and activity for individual salespeople.

12. A method for data analysis, comprising the steps of:
receiving raw data;
converting the raw data into a set of weighted values;
generating a set of scores from the weighted value;
generating a table having a square for each score of the set of scores, wherein each square has a color representing the associated score; and
presenting the table as output,
wherein the method is performed by a data processor comprising a CPU;
a non-volatile working memory; and a data storage.

13. The method for data analysis as recited in claim 12, further comprising the steps of preparing a textual summary for each square of the table, and presenting the textual summary of each square in the corresponding square.

14. The method for data analysis as recited in claim 13, wherein the step of preparing a textual summary for each square of the table is performed using natural language processing (NLP).

15. The method for data analysis as recited in claim 13, further comprising the step of determining one or more dominant elements for each square of the table from the weighted inputs, wherein the step of preparing a textual summary for each square of the table is performed by operating on the dominant elements associated with the square.

16. The method for data analysis as recited in claim 15, wherein the step of determining one or more dominant elements for each square of the table from the weighted inputs is performed by selecting weighted inputs having high scores and weighted inputs having low scores compared to an average score of the weighted inputs.

17. The method for data analysis as recited in claim 12, further comprising the steps of preparing one or more dashboards; and presenting the one or more dashboards as output.

18. The method for data analysis as recited in claim 17, wherein the one or more dashboards comprise a marketing dashboard showing an overview of sales campaigns, leads, leads without activity, converted leads, and value converted; a sales dashboard showing an overview of a number of leads, a sales pipeline, and salesperson activity; and a goals dashboard showing overall goals and activity, and goals and activity for individual salespeople.

19. A method for data analysis, comprising the steps of:
providing a data processor, comprising:
a CPU;
a non-volatile working memory; and
a data storage,
wherein the data processor is configured to receive raw data, operate on the raw data to generate processed data, and generate an output comprising a heat map illustrating the processed data;
providing raw data to the data processor; and
receiving output from the data processor.

20. The method for data analysis as recited in claim 19, wherein the processed data comprises a series of scores, and wherein the heat map comprises a series of squares, each square representing a score of the series of scores and having a color corresponding to the score.
